(19) United States
(12) Patent Application Publication
(10) Pub. No.: US 2023/0185627 A1
(43) Pub. Date: Jun. 15, 2023

(54) MANAGING LIFECYCLE OF AGENTS OF CLOUD SERVICES ACCORDING TO DESIRED STATE

(71) Applicant: VMware, Inc., Palo Alto, CA (US)

(72) Inventors: Prateek GUPTA, San Francisco, CA (US); Fnu YASHU, Sunnyvale, CA (US); John E. BREZAK, Camano Island, WA (US); Ivaylo Radoslavov RADEV, Sofia (BG)

(21) Appl. No.: 17/549,077

(22) Filed: Dec. 13, 2021

(51) Int. Cl. G06F 9/50; G06F 8/61

(52) U.S. Cl. CPC G06F 9/5077; G06F 9/5066; G06F 8/63

(57) ABSTRACT

A method of managing lifecycle of agents of cloud services running in a customer environment according to a desired state of the agents includes comparing a running state of the agents against the desired state. Upon determining that the running state includes a first agent that is not present in the desired state, the first agent is removed. Upon determining that the desired state includes a second agent that is not present in the running state, the second agent is deployed. Upon determining that there is a drift in the running state of a third agent from the desired state of the third agent, the third agent of the desired state is deployed while the third agent of the running state continues execution. The third agent of the running state is removed after the third agent of the desired state executes without errors for a period of time.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by management software that communicates with virtualization software (e.g., hypervisor) installed in the host computers.

As described in U.S. patent application Ser. No. 17/464,733, filed on Sep. 2, 2021, the entire contents of which are incorporated by reference herein, the desired state of the SDDC, which specifies the configuration of the SDDC (e.g., number of clusters, hosts that each cluster would manage, and whether or not certain features, such as distributed resource scheduling, high availability, and workload control plane, are enabled), may be defined in a declarative document, and the SDDC is deployed or upgraded according to the desired state defined in the declarative document.

The declarative approach has simplified the deployment and upgrading of the SDDC configuration, but may still be insufficient by itself to meet the needs of customers who have multiple SDDCs deployed across different geographical regions, and deployed in a hybrid manner, e.g., on-premise, in a public cloud, or as a service. These customers want to ensure that all of their SDDCs are compliant with company policies, and are looking for an easier way to monitor their SDDCs for compliance with the company policies and manage the upgrade and remediation of such SDDCs.

### SUMMARY

One or more embodiments provide cloud services for centrally managing the SDDCs. These cloud services rely on agents running in a cloud gateway appliance to deliver the cloud services to customer environments in which their SDDCs are deployed. New cloud services are delivered by installing new agents and existing cloud services are updated by upgrading the agents already installed.

One or more embodiments also provide a method of managing the lifecycle of agents of cloud services that are running in customer environments according to a desired state of the agents. The method includes the steps of: comparing a running state of the agents against the desired state; upon determining that the running state includes a first agent that is not present in the desired state, removing the first agent; and upon determining that the desired state includes a second agent that is not present in the running state, deploying the second agent.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a conceptual block diagram of customer environments of different organizations that are managed through a multi-tenant cloud control plane.

FIG. 2 illustrates components of cloud control plane and a cloud gateway appliance that are used in managing the lifecycle of agents according to the desired state.

FIG. 3 illustrates a sample desired state specification.

FIG. 4 is a flow diagram that depicts a method of updating agents according to embodiments.

FIG. 5 is a flow diagram that depicts a method of updating an agent according to embodiments.

FIG. 6 illustrates a new cloud service provisioned from the cloud control plane.

FIG. 7 illustrates a desired state specification used in deploying an agent of the new cloud service.

### DETAILED DESCRIPTION

One or more embodiments provide a method of managing the lifecycle of agents of cloud services running in cloud gateway appliances according to a desired state. The agents work with their associated cloud services to expose the service functionality to virtual infrastructure management servers that manage SDDCs. The lifecycle of these agents is tied to the lifecycle of the cloud services, not the customer's SDDC lifecycle. As a result, these agents isolate the SDDCs from the velocity of the cloud service changes. Managing the lifecycle of these agents according to the desired state is desirable because: (1) it requires no human intervention in the customer environments to keep the agents up to date; (2) agent update cycle is decoupled from upgrades of the cloud gateway appliances; (3) it requires only one configuration to start new agents, upgrade, deprecate, or remove an existing agent, and apply any configuration updates to the agents, and (4) it results in zero drift from the desired state and so all the latest available cloud services as well as any updates can be delivered to the customer seamlessly.

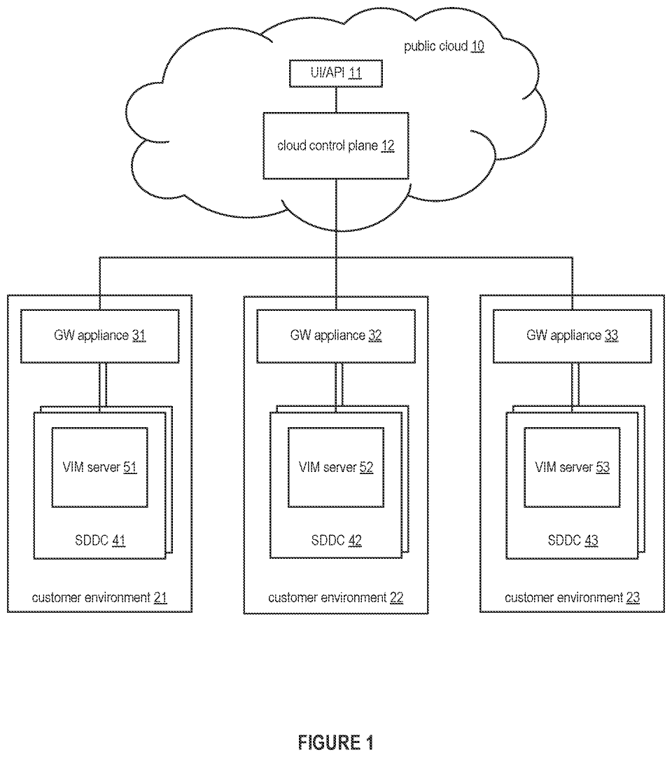

FIG. 1 is a conceptual block diagram of customer environments of different organizations (hereinafter also referred to as “customers” or “tenants”) that are managed through a multi-tenant cloud control plane 12, which is implemented in a public cloud 10. A user interface (UI) or an application programming interface (API) that interacts with cloud control plane 12 is depicted in FIG. 1 as UI/API 11.

A plurality of SDDCs is depicted in FIG. 1 in each of customer environment 21, customer environment 22, and customer environment 23. In each customer environment, the SDDCs are managed by respective virtual infrastructure management (VIM) servers, a commercial example of which is VMware vCenter® server. For example, SDDC 41 of the first customer is managed by VIM server 51, SDDC 42 of the second customer by VIM server 52, and SDDC 43 of the third customer by VIM server 53.

The VIM servers in each customer environment communicate with a gateway (GW) appliance, which hosts agents that communicate with cloud control plane 12 to deliver cloud services to the corresponding customer environment. For example, the VIM servers for managing the SDDCs in customer environment 21 communicate with GW appliance 31. Similarly, the VIM servers for managing the SDDCs in customer environment 22 communicate with GW appliance 32, and the VIM servers for managing the SDDCs in customer environment 23 communicate with GW appliance 33. Examples of cloud services that are delivered to the respective customer environments through the agents include SDDC inventory management, SDDC configuration management, and upgrading of the VIM servers with reduced downtime.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

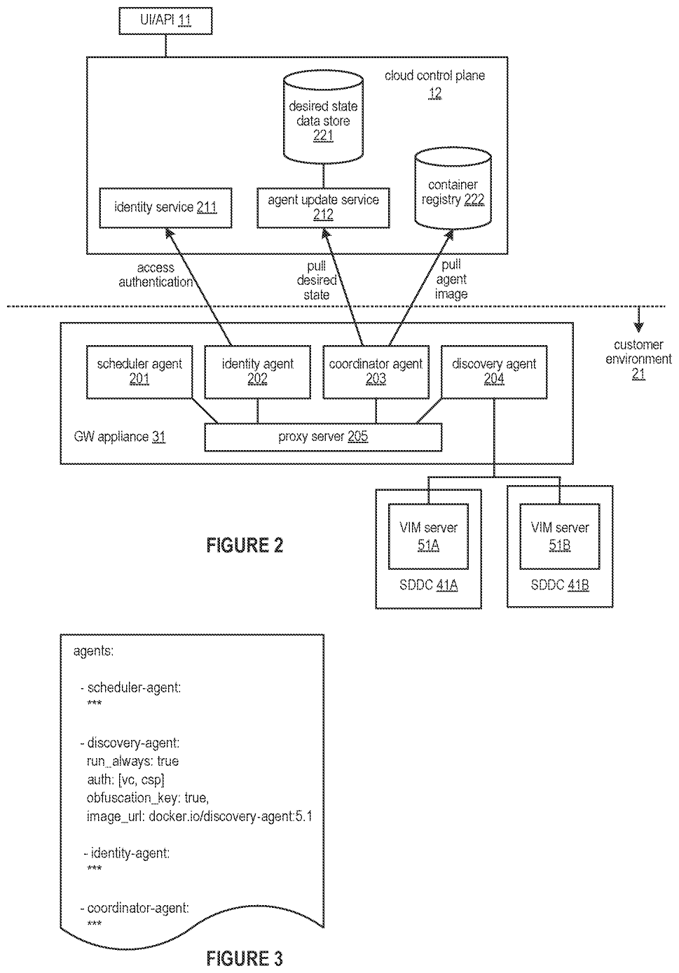

In the embodiments, the lifecycle of agents is managed according to a desired state of the agents. The desired state of the agents may be specified through UI/API 11 and expressed in a desired state specification. FIG. 2 illustrates components of cloud control plane 12 and a GW appliance (e.g., GW appliance 31) that are used in managing the lifecycle of agents according to the desired state. FIG. 3 illustrates a sample desired state specification.

Two cloud services are depicted in FIG. 2. They are identity service 211 and agent update service 212. Identity service 211 is responsible for authenticating tenants accessing cloud control plane 12 through UI/API 11 and authenticating GW appliances that want to establish cloud inbound connection with cloud control plane 12. Agent update service 212 is responsible for orchestrating updates to the agents according to the desired state. Desired state data store 221 is a repository for the desired state specifications. Container registry 222 is a repository for container images corresponding to the different agents that can be deployed in the gateway appliances.

Components of GW appliance 31 depicted in FIG. 2 include agents of cloud services, namely a scheduler agent 201 for deploying agents and removing agents (as used herein, “deploying an agent” means executing an instance of the agents and “removing an agent” means terminating the executing instance of the agent), identity agent 202 for authenticating the GW appliance to cloud control plane 12, coordinator agent 203 for coordinating updates to the agents according to the desired state, discovery agent 204 for communicating with the VIM servers, and a proxy server 205 for handling external communications to agents. Internal communications between agents are handled through APIs. During the agent update process, coordinator agent 203 pulls the desired state specification from agent update service 212 and if there are any agents to be deployed or updated according to the desired state, pulls container images of these agents from container registry 222.

FIG. 3 illustrates a desired state specification for agents deployed in GW appliance 31. This specification defines all of the agents that are to be deployed and the configurations for each such agent. In FIG. 3, the configurations for the discovery agent are depicted, and include the location of the container image for the discovery agent, “image_url: docker.io/discovery-agent:5.1.”

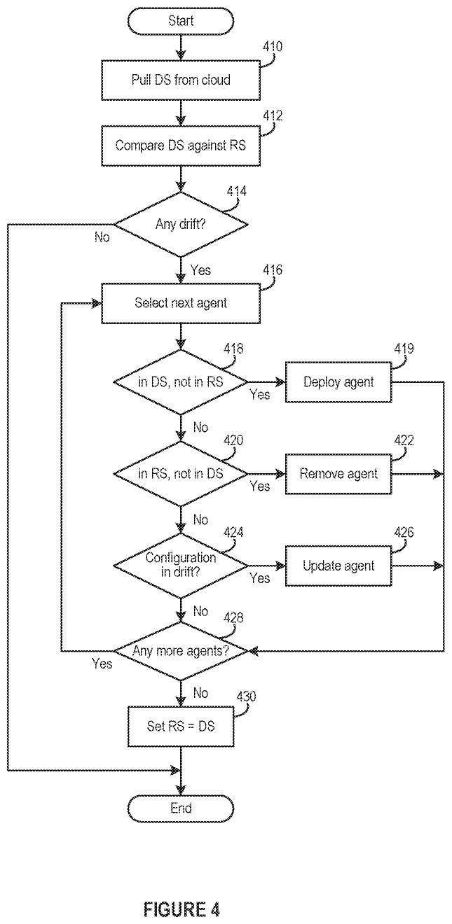

FIG. 4 is a flow diagram that depicts a method of updating agents according to embodiments. The method of FIG. 4 begins at step 410 with the pulling of the desired state specification from agent update service 212 by coordinator agent 203. Then, at step 412, coordinator agent 203 compares the desired state against a running state of the agents, which it maintains in memory. If there are any difference between the desired state and the running state, coordinator agent 203 determines that there is drift (step 414, Yes) and step 416 is executed next. If there is no difference, the method ends.

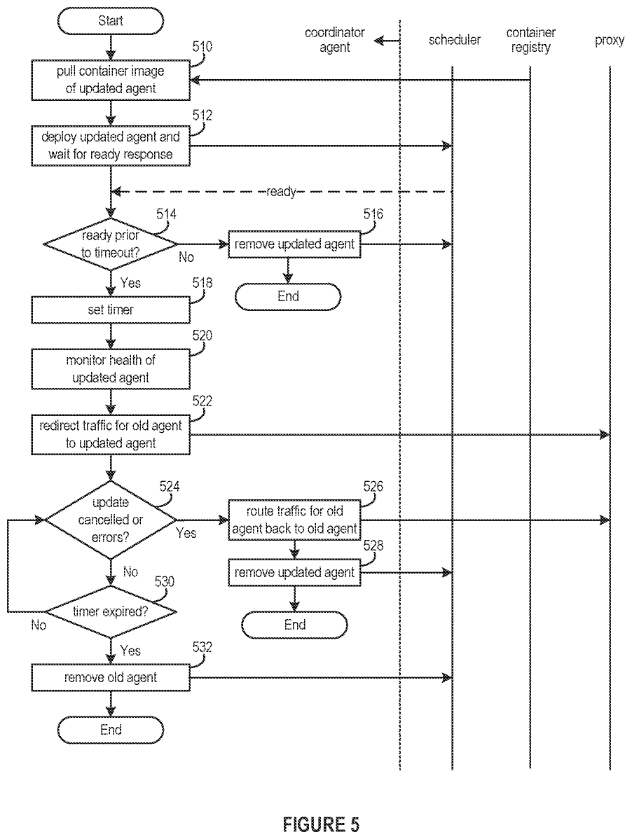

At step 416, coordinator agent 203 selects one agent to determine if the running state needs to be remediated to match the desired state. If the selected agent is in the desired state but not in the running state (step 418, Yes), coordinator agent 203 determines this agent to be a new agent and at step 419 pulls a container image of the new agent from a location of the container image specified in the desired state specification, and invokes an API of scheduler agent 201 to deploy the new agent with the running configuration defined in the desired state specification. If the selected agent is in the running state but not in the desired state (step 420, Yes), coordinator agent 203 determines this agent needs to be removed and at step 422 invokes an API of scheduler agent 201 to remove this agent. If the configuration of the selected agent defined in the desired state is different from the configuration of the selected agent defined in the running state, coordinator agent 203 determines the configuration of the selected agent to be in drift (step 424, Yes), and at step 426 carries out the update agent process illustrated in FIG. 5.

At step 428, coordinator agent 203 determines if there is another agent to select for remediation. If there is (step 428, Yes), the method returns to step 418, where another agent is selected. If there is no more (step 428, No), coordinator agent 203 at step 430 replaces the running state that is stored in memory with the desired state so that the desired state now becomes the running state, and the method ends.

FIG. 5 is a flow diagram that depicts a method of updating an agent according to embodiments. In this method, an updated agent is deployed and executed in parallel with the currently running agent (referred to herein as the “old agent”). The updated agent may be an upgrade version of the old agent, and it may even be a deprecated version of the old agent, e.g., in cases where software bugs were discovered in the upgrade version after the release of the upgrade version. In both of these cases, the updated agent and the old agent have different code bases. In some cases, the code bases are the same and only the running configurations are different between the updated agent and the old agent.

The method of FIG. 5 begins at step 510. At this step, coordinator agent 203 pulls the container image of the updated agent from a location of the container image specified in the desired state specification. Then, at step 512, coordinator agent 203 invokes an API of scheduler agent 201 to deploy the updated agent with the running configuration specified in the desired state specification and wait for a ready response from scheduler agent 201. If the ready response is not returned by scheduler agent 201 within a timeout period (step 514, No), coordinator agent at step 516 invokes an API of scheduler agent 201 to remove the updated agent. The method ends thereafter.

If the ready response is returned by scheduler agent 201 within the timeout period (step 514, Yes), coordinator agent 203 sets a timer at step 518. The time value set in the timer represents a time period for testing the operational health of the updated agent. At step 520, coordinator agent 203 issues APIs (e.g., to health monitoring agents running in the GW appliance) to begin monitoring the operational health of the updated agent. Then, at step 522, coordinator agent 203 instructs proxy server 205 to redirect traffic destined for the old agent to the updated agent.

If the agent update is cancelled or errors are detected in the operational health of the updated agent (step 524, Yes), coordinator agent 203 at step 526 instructs proxy server 205 to route traffic destined for the old agent back to the old agent, and invokes an API of scheduler agent 201 to remove the updated agent. The method ends thereafter.

On the other hand, if the agent update is not cancelled and no errors are detected in the operational health of the updated agent (step 524, No) during the entire time period for testing the operational health of the updated agent (step 530, Yes), coordinator agent 203 at step 532 invokes an API of scheduler agent 201 to remove the old agent. The method ends thereafter.

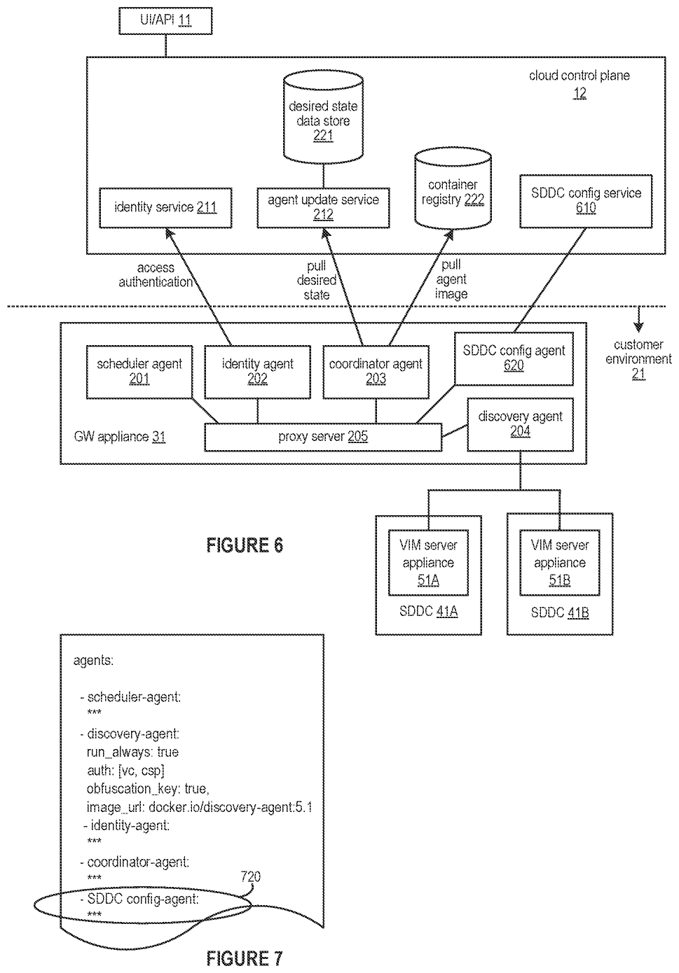

FIG. 6 illustrates a new cloud service provisioned from cloud control plane 12. The new cloud service is depicted in FIG. 6 as SDDC configuration service 610, which is a service that enables SDDC configurations to be managed from the cloud. The agent of this cloud service is SDDC configuration agent 620. To deploy SDDC configuration agent 620 in GW appliance 31, a desired state specification depicted in FIG. 7 is created through UI/API 11. This document contains a new section 720 for SDDC configuration agent (SDDC config-agent:). When coordinator agent 203 executes the method of FIG. 4, a container image of SDDC configuration agent 620 will be pulled from container registry 222 and deployed on GW appliance 31 as shown in FIG. 6.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing lifecycle of agents of cloud services running in a customer environment according to a desired state of the agents, said method comprising:
comparing a running state of the agents against the desired state;
upon determining that the running state includes a first agent that is not present in the desired state, removing the first agent; and
upon determining that the desired state includes a second agent that is not present in the running state, deploying the second agent.

2. The method of claim 1, further comprising:
upon determining that a third agent is present in both the desired state and the running state and there is a drift in the running state of the third agent from the desired state of the third agent, deploying the third agent of the desired state while continuing to execute the third agent of the running state; and
upon confirming that the third agent of the desired state is running without errors for a period of time, removing the third agent of the running state.

3. The method of claim 2, further comprising:
after deploying the third agent of the desired state, redirecting traffic destined for the third agent of the running state to the third agent of the desired state.

4. The method of claim 3, further comprising:
upon confirming that the third agent of the desired state is running with errors, routing the traffic destined for the third agent of the running state back to the third agent of the running state, and terminating the third agent of the desired state.

5. The method of claim 2, further comprising:
prior to deploying the third agent of the desired state, downloading an executable image of the third agent from a storage location specified in the desired state.

6. The method of claim 1, further comprising:
prior to deploying the second agent, downloading an executable image of the second agent from a storage location specified in the desired state.

7. The method of claim 1, wherein the second agent enables a new cloud service that is not currently provided by the running state.

8. A non-transitory computer readable medium comprising instructions to be executed in a computer system to carry out a method of method of managing lifecycle of agents of cloud services running in a customer environment according to a desired state of the agents, said method comprising:
comparing a running state of the agents against the desired state;
upon determining that the running state includes a first agent that is not present in the desired state, removing the first agent; and
upon determining that the desired state includes a second agent that is not present in the running state, deploying the second agent.

9. The non-transitory computer readable medium of claim 8, wherein the method further comprises:
upon determining that a third agent is present in both the desired state and the running state and there is a drift in the running state of the third agent from the desired state of the third agent, deploying the third agent of the desired state while continuing to execute the third agent of the running state; and
upon confirming that the third agent of the desired state is running without errors for a period of time, removing the third agent of the running state.

10. The non-transitory computer readable medium of claim 9, wherein the method further comprises:
after deploying the third agent of the desired state, redirecting traffic destined for the third agent of the running state to the third agent of the desired state.

11. The non-transitory computer readable medium of claim 10, wherein the method further comprises:
upon confirming that the third agent of the desired state is running with errors, routing the traffic destined for the third agent of the running state back to the third agent of the running state, and terminating the third agent of the desired state.

12. The non-transitory computer readable medium of claim 9, wherein the method further comprises:
prior to deploying the third agent of the desired state, downloading an executable image of the third agent from a storage location specified in the desired state.

13. The non-transitory computer readable medium of claim 8, wherein the method further comprises:
prior to deploying the second agent, downloading an executable image of the second agent from a storage location specified in the desired state.

14. The non-transitory computer readable medium of claim 8, wherein the second agent enables a new cloud service that is not currently provided by the running state.

15. A computer system running in a customer environment and communicating with a cloud control plane to manage lifecycle of agents of cloud services that are provisioned to the customer environment from the cloud control plane, wherein the computer system is programmed to carry out the steps of:
retrieving a desired state of the agents from the cloud control plane;
comparing a running state of the agents against the desired state;
upon determining that the running state includes a first agent that is not present in the desired state, removing the first agent; and
upon determining that the desired state includes a second agent that is not present in the running state, deploying the second agent.

16. The computer system of claim 15, wherein the steps further comprise:
upon determining that a third agent is present in both the desired state and the running state and there is a drift in the running state of the third agent from the desired state of the third agent, deploying the third agent of the desired state while continuing to execute the third agent of the running state; and
upon confirming that the third agent of the desired state is running without errors for a period of time, removing the third agent of the running state.

17. The computer system of claim 16, wherein the steps further comprise:
after deploying the third agent of the desired state, redirecting traffic destined for the third agent of the running state to the third agent of the desired state.

18. The computer system of claim 17, wherein the steps further comprise:
upon confirming that the third agent of the desired state is running with errors, routing the traffic destined for the third agent of the running state back to the third agent of the running state, and terminating the third agent of the desired state.

19. The computer system of claim 16, wherein the steps further comprise:
prior to deploying the third agent of the desired state, downloading an executable image of the third agent from a storage location specified in the desired state.

20. The computer system of claim 15, wherein the steps further comprise:
prior to deploying the second agent, downloading an executable image of the second agent from a storage location specified in the desired state.
